(19) United States
(12) Patent Application Publication
(10) Pub. No.: US 2012/0196016 A1
(43) Pub. Date: Aug. 2, 2012

(54) Tank for the storage and/or maturation of an alcoholic beverage

(76) Inventor: Neal PALMER, Adelaide (AU)

(21) Appl. No.: 13/019,111

(22) Filed: Feb. 1, 2011

(51) Int. Cl. C12G 1/00; B65D 25/00; B01F 3/04

(52) U.S. Cl. 426/474; 261/101; 99/323.1; 220/737

(57) ABSTRACT

A method and apparatus for the storage and/or maturation of an oxygen sensitive liquid beverage including: a vessel or tank adapted to hold a quantity of the liquid therein, said vessel having a low oxygen transfer rate from the atmosphere facilitating the reductive storage of said liquid; and a means of accommodating a gas permeable membrane, said gas permeable membrane having a high oxygen transfer rate relative to the vessel; wherein said membrane is in contact with said liquid thereby increasing the exposure of said liquid to oxygen in result.

### FIELD OF THE INVENTION

The present invention relates to the storage and/or maturation of an alcoholic beverage in particular to the maturation of wine.

### BACKGROUND OF THE INVENTION

Traditionally wooden barrels have been used to store and mature alcoholic beverages such as wine. Wood barrels are used because they allow the wine to breath during the maturation process and they impart favourable characteristics to the wine. The difficulty with wooden barrels is that they are expensive and only have a limited life. After roughly three years, most of a barrel's flavour compounds have been leached out and the pores in the wood have become clogged with detritus and are not able to function effectively. The wood barrels also allow for the evaporation and potentially the leakage of wine which means that they need to be topped up at intervals during the maturation process. Typically the barrel is topped up from another barrel.

More recently stainless steel vessels have become popular. These vessels allow for bulk storage and maturation of wine. However they require the manual addition of oxygen (micro-oxygenation) and oak planks or chips. Furthermore, pitting of the stainless steel interior can destroy the integrity of the tank thereby rendering the tank useless. Pitting can occur when stainless steel is subjected to high concentration of chloride ions such as during cleaning of the vessel with a mild caustic solution.

During the maturation process oxygen must be rationed to the wine. If too much oxygen comes into contact with the wine the oxidation of ethanol will produce vinegar. Accordingly it is important to minimise the atmospheric air coming into direct contact with the wine during maturation. This is particularly important in the headspace or ullage of the maturation vessel. If oxygen is not minimised in the headspace it can lead to aerobic bacterial spoilage of the wine. As can be appreciated the resultant formation of scum and mound is detrimental to the wine.

In recent times thin walled polyethylene vessels have been used to mature wine. Polyethylene is easy to sanitise and can be cleaned with mild caustic preparation without the risks associated with stainless steel vessels. Furthermore, the material is gas permeable which allows for the rationing of oxygen. Unlike traditional wooden barrels however the material does not have pores that clog over time. The material therefore is therefore good at retaining its gas permeability.

A problem with thin walled polyethylene vessels is that because they are flexible, they are difficult to transport. Furthermore, the vessels tend to expand and distort out of shape which can pose problems if they are being stored in close proximity to other vessels. The containers are also, because of thickness limitations to obtain the desired oxygen permeability, relatively fragile and need to be supported from collapsing under hydro static loads,

Further still, wineries often require vessels which they can use not only for maturation purposes, but also for long term storage. Vessels constructed completely of gas permeable material are suitable only for maturation of liquid because of the thin walled polyethylene properties. They also fail to promote the controlled ingress of oxygen into the vessels during maturation, fermentation and oxygen exclusion. They are not suitable for holding liquid in a sealed inert environment, which means that additional gas impermeable vessels typically need to be purchased.

A yet further problem encountered with prior art vessels of this type is that they typically include internal threads or fasteners for attaching a valve to the vessel. This often presents leaking, cleaning and sterilisation issues in that the internal fittings may promote, allow or permit the propagation of bacteria, such as acetobactors, which may spoil the wine.

It is therefore an object of the present invention to overcome at least some of the aforementioned problems or provide the public with a useful alternative.

### SUMMARY OF THE INVENTION

Therefore in one form of the invention there is proposed an apparatus for the storage and/or maturation of a liquid, including: a vessel adapted to hold a quantity of the liquid therein, said vessel having a low oxygen transfer rate to facilitate long term storage of said liquid; and a means of accommodating a gas permeable membrane in a headspace of said vessel, said gas permeable membrane having a high oxygen transfer rate relative to the vessel to facilitate the controlled ingress of oxygen into said vessel.

In a further form of the invention there is proposed an apparatus for storage and/or maturation of a liquid, including: a vessel adapted to hold a quantity of the liquid therein; a substantially rigid frame including a base plate adapted to support said vessel and prevent undesirable expansion of the vessel, said base plate being angled to facilitate draining of liquid out from the vessel.

In a still further form of the invention there is proposed an apparatus for storage and/or maturation of a liquid, including: a vessel adapted to hold a quantity of the liquid therein; and a valve system including an integrally formed fitting extending a predetermined distance outwardly from a wall of said vessel, said fitting configured to receive a valve using an external fastening means, said valve used to control the passage of liquid there through.

In a yet further form of the invention there is proposed an apparatus for storage and/or maturation of a liquid, including: a vessel adapted to hold a quantity of the liquid therein, said vessel having a low oxygen transfer rate to facilitate long term storage of said liquid; a means of accommodating a gas permeable membrane in a headspace of said vessel, said gas permeable membrane having a high oxygen transfer rate relative to the vessel to facilitate controlled ingress of oxygen into said vessel; a valve system including an integrally formed fitting extending a predetermined distance outwardly from said vessel, said fitting configured to receive a valve using an external fastening means, said valve adapted to control the passage of liquid there through; and a substantially rigid frame including a base plate adapted to support said vessel and prevent undesirable expansion of the vessel, said base plate being angled to facilitate stacking of said frames, and draining of liquid.

Preferably the liquid is wine.

In preference the wine is housed within the flexible vessel for the purposes of maturation.

Alternatively the wine is housed within the flexible vessel for the purposes of storage.

Most preferably the vessel is constructed from polyethylene.

Preferably the base of the frame is adapted to accommodate the prongs of a forklift.

In preference the bung tap includes a connection member adapted to be connected to a hose which is in communication with a source of compressed inert gas.

Preferably, the fluid passage is located at the lowest point of the sump.

In preference the apparatus includes an internal frame which is adapted to suspend at least one wooden member for the purpose of oaking of the liquid contained therein.

In a still further form of the invention there is proposed an apparatus for the storage and/or maturation of a liquid, including: a vessel adapted to hold a quantity of the liquid therein, said vessel having a low oxygen transfer rate to facilitate long term storage of said liquid; and a means delivering gas into a permeable member located within the liquid, said permeable member having a high oxygen transfer rate relative to the vessel to facilitate the controlled ingress of oxygen into said vessel.

In preference said means of delivering oxygen into the permeable member is an impermeable tube sealingly engaged to the vessel and having an upper opening exposed to the atmosphere and a lower opening in fluid connection with a permeable member, the permeable member located wholly within the liquid contained within the vessel and sealed against any liquid flow into the permeable member.

### BRIEF DESCRIPTION OF THE DRAWINGS

The accompanying drawings, which are incorporated in and constitute a part of this specification, illustrate several implementations of the invention and, together with the description, serve to explain the advantages and principles of the invention. In the drawings,

FIG. 1 illustrates a perspective view of a tank system of the present invention in a stacked arrangement;

FIG. 2 illustrates a perspective view of stacked tank frames forming part of the system of FIG. 1, in accordance with a first aspect of the present invention;

FIG. 3 illustrates an enlarged perspective view of a tank lid forming part of the tank system of FIG. 1, in accordance with a second aspect of the invention;

FIG. 4 illustrates an exploded, perspective view of the tank lid of FIG. 3, separated from the tank;

FIG. 5 illustrates an enlarged perspective view of a tank base forming part of the tank system of FIG. 1, including an enlarged, exploded view of the tank valve in accordance with a third aspect of the invention; and

FIG. 6 illustrates a second embodiment of the invention where oxygen transfer occurs to the liquid in the vessel within the liquid.

### DESCRIPTION OF THE PREFERRED EMBODIMENTS

The following detailed description of the invention refers to the accompanying drawings. Although the description includes exemplary embodiments, other embodiments are possible, and changes may be made to the embodiments described without departing from the spirit and scope of the invention. Wherever possible, the same reference numbers will be used throughout the drawings and the following description to refer to the same and like parts.

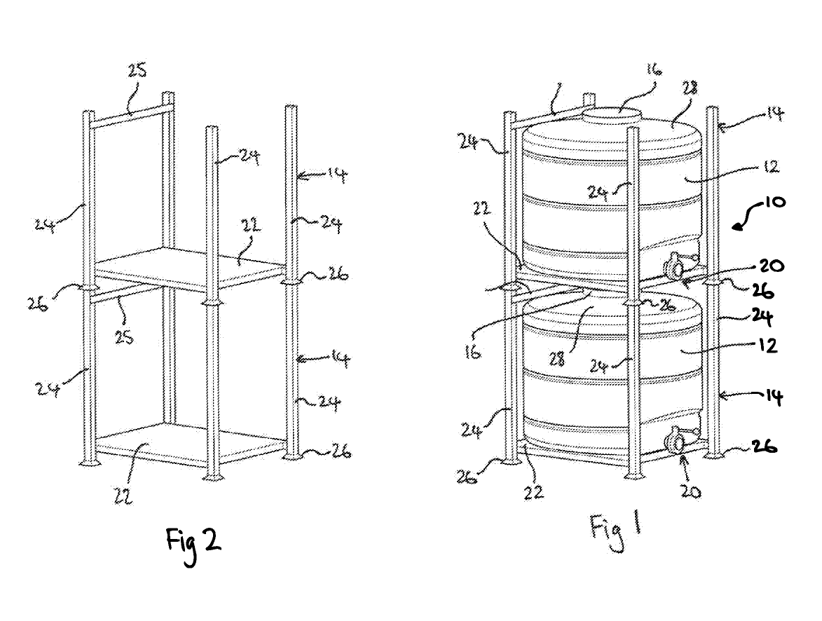

Referring to the drawings for a more detailed description, an apparatus or unit 10 is illustrated, demonstrating by way of example one arrangement in which the principles of the present invention may be employed. The apparatus 10, as illustrated in FIG. 1, includes a flexible vessel or tank 12 and a substantially rigid frame 14. FIG. 1 illustrates apparatus 10 in a stacked arrangement with two individual units placed one on top of the other. As would be appreciated the ability to stack the units has significant space saving advantages. Each tank 12 includes a headspace defined by a lid 16, and a valve assembly 20.

The frame 14 includes a substantially square base plate 22 supported in an elevated configuration by four upright legs 24 located at each corner. It is envisaged that the legs 24 will be constructed from steel square hollow sections (shs) or rectangular hollow sections (rhs) to provide the greatest strength whilst minimising the overall weight of the apparatus. The frame 12 further includes at least one brace member 25 joining two of the legs 24.

The base 22 is of a strength which allows a forklift to be used to transport the frame 14 by inserting forklift prongs beneath the plate 22. In this way each unit 10 can be moved independently for the purposes of storage, cleaning or accessing the wine contained therein. Although not shown specifically in the drawings, the frame 14 also includes a forklift intrusion guard protecting the base of the tank from accidental intrusion by forklift prongs.

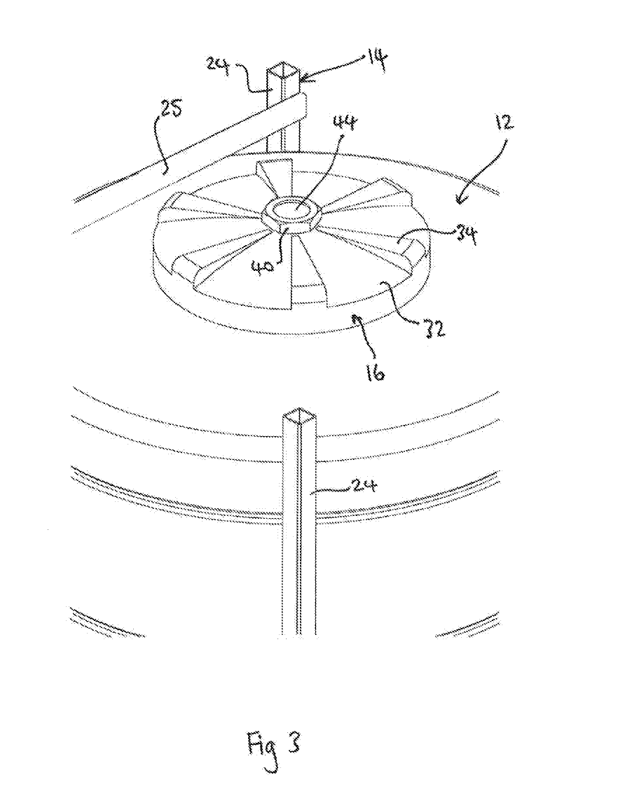

Each leg 24 terminates at the bottom end in a locating lug 26, which may for example be welded to the leg 24. The upper end of each leg 24 is adapted to be received in a corresponding locating lug 26 of a frame 14 stacked there above, as illustrated in FIGS. 1-2.

The tank 12 is preferably constructed from a food grade polyethylene polymer that is inert to wine. The material is inherently gas permeable, however, the tanks have a wall thickness, material density, and surface area to volume ratio's which are specifically formulated to allow for inert longer term storage. The tank wall could be coloured or translucent for clear view of contents and fill levels, and is of a heavy wall cylindrical design. This eliminates side wall bulging and the requirement for the frame to support the wall preventing it from bulging, and also assists cleaning. The tank is preferable rotationally moulded.

In being configured this way, the tank 12 is also prevented from expanding undesirably. This also allows for unit 10 to be placed in close proximity to another without the risk of the tank 12 expanding in such a way as to encroach upon another unit 10. As the reader would appreciate, if this was to occur between adjacent stacks it may result in a domino effect with disastrous consequences.

It is envisaged that the tank 12 will be constructed out of polyethylene of a thickness which limits oxygen permeating through the tank walls. This ensures that the tank 12 can be used as a long term storage tank for many oxygen sensitive foodstuffs.

Polyethylene is easy to sanitise and can be cleaned with mild caustic preparation without the risks associated with cleaning of stainless steel vessels with this type of solution. Furthermore the material does not have pores that clog over time as occurs in traditional wooden barrels.

As is further illustrated in FIGS. 1 and 2, the base plate 22 of the frame 14 is slightly angled towards one side. For example, in the embodiment shown, the plate 22 is higher on the brace side than on the opposed side of the frame 14. The tank 12 is adapted to be lowered onto the plate 22 between the legs 24 so that the valve assembly 20 is located at the lowest position of the angled plate 22 to facilitate flow out of the tank 12. The valve assembly 20, which shall be described in more detail below, can be used for both an inlet and an outlet for wine. The valve assembly 20 is also used during the cleaning process to remove the used mild caustic solution.

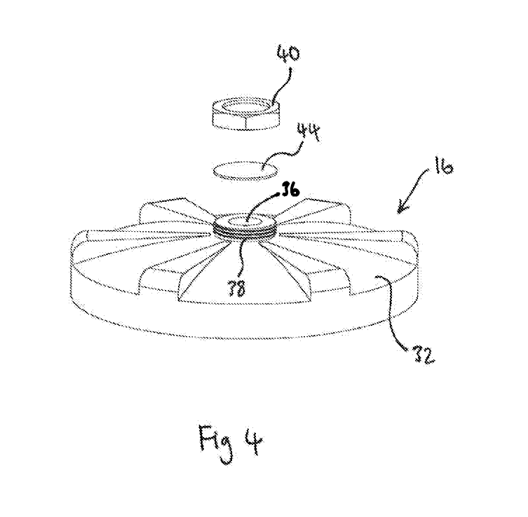

As illustrated in FIG. 3 the upper surface 28 of the tank 12 slopes upwardly and inwardly towards the headspace. This prevents air pockets from forming as the tank 14 is filled with wine. The apparatus 10 may further include an internal frame adapted to suspend portions of oak (not shown) within the wine. It is envisaged that the frame 14 will include at least one removable portion which is adapted to engage the oak portions. In this way the oak can be easily removed from the tank at any desired time during maturation of the wine.

As mentioned, the headspace is defined by the round lid 16 of the tank 12, shown in detail in FIG. 4. The lid 16 includes a body 32 having upper strengthening ribs 34 and a central aperture 36 defined by a male threaded shaft 38 which upstands from the body 32. In a preferred embodiment, the male threaded shaft 38 is integrally moulded with the body 32. The male threaded shaft 38 is adapted to be engaged by a female threaded nut 40. Wedged between the threaded components to thereby seal aperture 35 is a liquid tight closure plate or membrane 44.

The closure membrane 44 can be made of a range of materials depending on the desired effect inside the tank 12. For example, where oxygen transfer is required for the purpose of driven maturation, the closure membrane 44 could be in the form of a gas permeable silicon rubber membrane. Such membranes are significantly more permeable than polyethylene, and therefore require only a fraction of the surface area to permit equivalent oxygen transfers, hence the small membrane in the lid of the tank. Should the tank be required for reductive oxygen storage only, then the membrane 44 would be of a gas impermeable material. Alternatively, for storage purposes, the nut 40 could simply be replaced with a cap nut (not shown).

It is further envisaged that the apparatus 10 will include multiple membrane types to suit specific jobs. For example, some wine may require greater oxygen transfer rates than others, and so a more gas permeable membrane 44 will be required, in comparison to a membrane used for wine that requires little oxygen rationing. It is to be further understood that the position of the membrane 44 need not be limited to the tank lid.

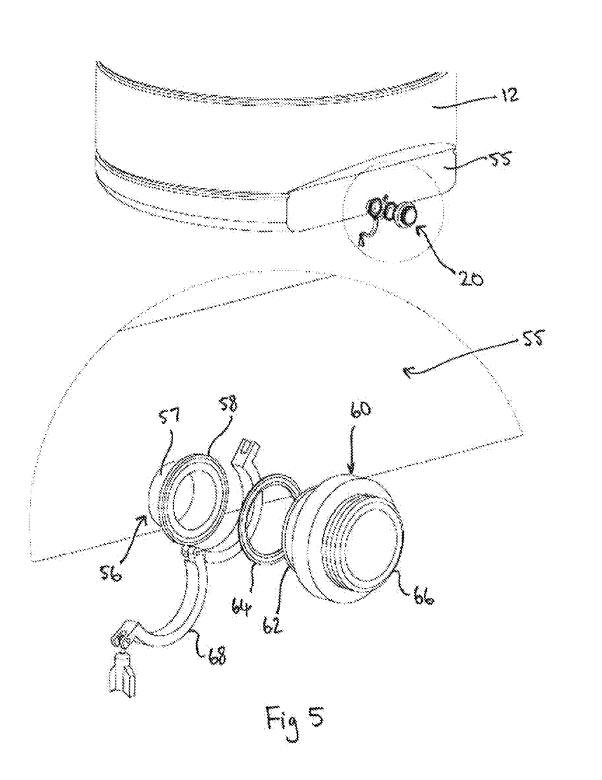

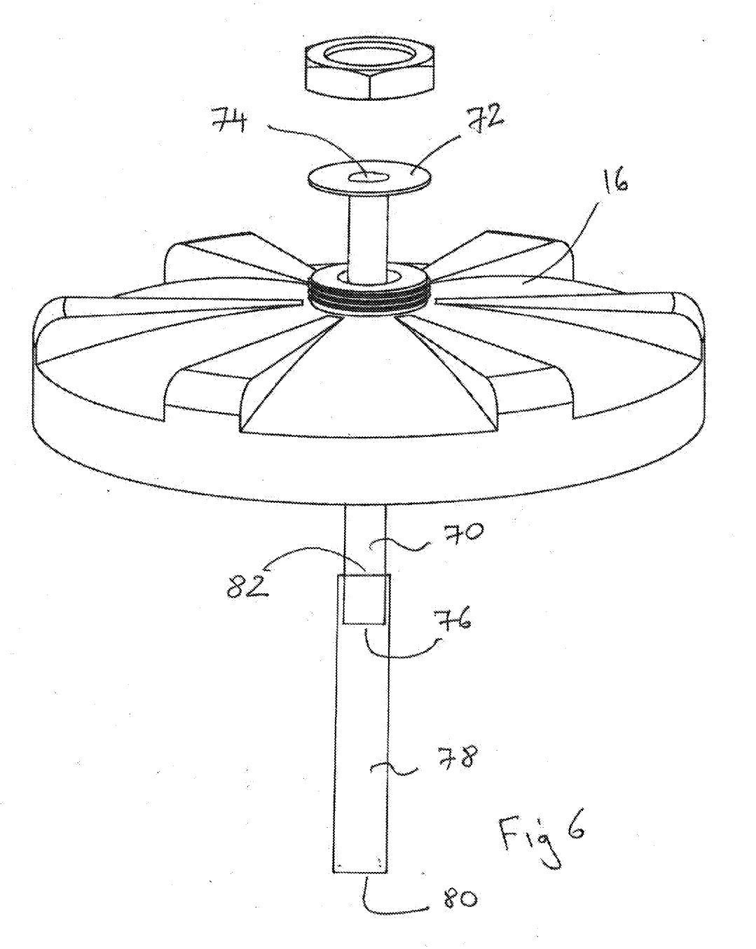

FIG. 5 illustrates the valve assembly 20 in more detail. The valve assembly 20 is located in a low profile side wall recess 55 in the tank body at its base, and includes a fitting 56 which is integrally moulded with the tank wall. The fitting 56 is in the form of a circular cross section pipe 57 which extends forwardly from the tank 12 a short distance, and terminates in an annular shoulder 58. A valve 60 includes an annular rearward portion 62 adapted to compress a gasket seal 64 against shoulder 58, and a forwardly extending male threaded portion 66. A hinged clamp 68 is used to couple the valve 60 and the fitting 56 by enclosing and gripping against both the fitting shoulder 58 and the rearward portion of the valve 60.

The male threaded portion 66 is then available for engagement with a female thread on the end of a hose fitting (not shown) for the purpose of transferring the vessel's liquid contents through the hose.

This feature of the apparatus 10 is important because it does away with the need for internal fasteners, which are a common cause of bacteria propagation, leakage, and wine spoilage. In this case, the fitting 56 forms an integral part of the tank 12, and the clamp 68 which is used to attach the valve 60 is an external fastener. The fitting is then able to communicate with known and standard hygienic fittings typically used by wineries, and the chance of bacteria propagation is greatly minimised. Although not shown, the tank 12 should also include a means of purging.

The skilled addressee will now appreciate the many advantages of the present invention. The tank 12 provides unparalleled versatility in that it can be used as both a maturation vessel and a long term safe storage vessel, simply by changing between different membranes in the lid of the tank. For example, a wine maker would be able to successfully switch between barrel rates of oxygen driven maturation (up to 50 ml/l/yr), and inert longer term storage (<5 ml/l/yr). The unit 10 creates opportunities for the controlled ingress of oxygen during maturation, fermentation and oxygen exclusion, whilst safely storing wine in a vessel capable of doubling cellar storage space by comparison with traditional oak barrel storage. Furthermore, the units 10 are particularly easy to clean, use a fraction of barrel cleaning resources, provide for complete control of oak integration and variation, do not require topping up, and are easily stacked and transported.

It is envisaged that when say 4×4×4 units are stacked up, they will store up to 64,000 lts of wine. The same floor storage space and stack height using oak barrels stacked using typical barrel racks will store around 34,000 lts of wine only.

Referring now to FIG. 6 there is illustrated a further embodiment of the present invention that can introduce controlled amounts of oxygen into wine. Instead of the membrane 44 (or used in addition to it) an impermeable tube 70 extends into the wine and below the wine surface. The tube 70 includes an upper flange 72 that sits on top of the lid 16 thus supporting the tube 70. Generally cylindrical the tube 70 has an upper opening 74 and a lower opening 76, the lower opening extending well below the wine surface. Fitted to the end of the tube adjacent lower opening 76 is a permeable member or tube 78 sealed at its lower end 80 and having an upper opening 82. The dimensions of both the impermeable tube 70 and the permeable tube 78 are chosen so that they sealingly engage each other at the lower opening 76 of the impermeable tube and the upper opening 82 of the permeable tube. Shown is the permeable tube extending around the impermeable tube, but of course it may also be the permeable tube being held within the impermeable tube in a mating arrangement. The extent of overlap between the two tubes will depend on their size and weight, that being dictated by the overall design and would be known to those versed in the art provided that it ensures that no wine can flow into the permeable tube 78. To assist in securing the two together one could always consider having a hose barb or a clamp band, although these are not illustrated herein.

Through its opening 74 the impermeable tube allows the passage of gases in and out of both the permeable and impermeable tubes. This opening may be covered by the previously illustrated flat permeable membrane 44 which then regulates the rate of oxygen ingress into the tube. Alternatively an impermeable flat seal may cover or a bung may be inserted into the upper aperture to prevent any oxygen ingress into the tube.

The impermeable tube is fastened and sealed to the lid or out side of the vessel.

It is an important feature of this embodiment that the ingress of atmospheric oxygen into the impermeable tube 70 is at a rate greater than that which oxygen may permeate through the lower permeable section of the tube 78 into the wine mass. Thus the oxygen content of the tube remains essentially equal with that of the prevailing atmospheric conditions. This feature allows the apparatus to introduce oxygen into the wine mass at controlled rates for the maturation of wine without the need for pressurising the tube or the requirement for oxygen to be driven through the tube by mechanical metering means as is the case with prior micro oxygenation apparatus. The current invention will introduce oxygen into a vessel containing wine at rates of between 5 ml/lt/yr and 200 ml/lt/yr.

The impermeable tube is preferably made of stainless steel whilst the permeable tube is made from food grade material having known oxygen permeability properties.

The reader should now appreciate the advantages of this embodiment. Having the permeable tube submerged under the wine surface prevents oxygen building up in the headspace of the wine vessel. High levels of oxygen in the headspace can encourage the cultivation of acetobactors on the wine surface which in high populations can result in wine spoilage.

The amount of oxygen ingress may be varied by adjusting the wall thickness and/or surface area and/or length of permeable tube to compensate for varying capacity wine vessels and the wines potential to consume the oxygen through oxidative reactions.

The apparatus may be adapted to be used in many types of wine storage vessels including polyethylene, stainless steel and oak barrels. In the case of oak barrels the impermeable section of the tube may fit into and pass through the upper sealing bung.

Unlike of other forms of micro oxygenation the apparatus does not require oxygen to be pumped through the tube by means of an elaborate and precise mechanical metering apparatus. Such apparatus requires a power source to introduce optimal amounts of oxygen to wine for the purpose of controlled maturation. Any failure of this apparatus or the power source can have disastrous consequences. Further such apparatus requires a tube to transport oxygen or air from the metering apparatus to vessels storing wine. It should be appreciated that when smaller vessels are stacked in high density with each vessel having its own supply tube the potential for varying rates of metered oxygen ingress into individual vessels is limited. Further and where the vessels are in a stacked arrangement the supply tubes must be removed before the vessel can be moved, this procedure may be required to occur at considerable height and limits accessibility.

Further advantages and improvements may very well be made to the present invention without deviating from its scope. Although the invention has been shown and described in what is conceived to be the most practical and preferred embodiment, it is recognized that departures may be made therefrom within the scope and spirit of the invention.

Any discussion of the prior art throughout the specification should in no way be considered as an admission that such prior art is widely known or forms part of the common general knowledge in this field.

In the summary of the invention, except where the context requires otherwise due to express language or necessary implication, the word “comprising” is used in the sense of “including”, i.e. the features specified may be associated with further features in various embodiments of the invention.

1. A method and apparatus for the storage and/or maturation of an oxygen sensitive liquid beverage including: a vessel or tank adapted to hold a quantity of the liquid therein, said vessel having a low oxygen transfer rate from the atmosphere facilitating the reductive storage of said liquid; and a means of accommodating a gas permeable membrane, said gas permeable membrane having a high oxygen transfer rate relative to the vessel; wherein said membrane is in contact with said liquid thereby increasing the exposure of said liquid to oxygen in result

2. A vessel according to claim 1 wherein said vessel includes a main body portion and an opening in said main body portion, said opening adapted to be sealed by a removable body portion, whereby said removable body portion accommodates a gas permeable membrane, said membrane having a high oxygen transfer rate from the atmosphere relative to said vessel.

3. A tank according to claim 1 wherein said gas permeable membrane is in the form of a tube that permeates oxygen into the contained liquid directly from the atmosphere at a rate greater than 5 ml/lt/yr without mechanical means.

4. A tank according to claim 2 wherein said vessel walls are gas impermeable.

5. A tank according to claims 2 wherein said main body portion includes a base, a side wall, and a ceiling defining a headspace in said tank, said opening being disposed in said headspace, and said removable body portion being in the form of a removable membrane adapted to seal said opening.

6. A tank according to claim 5 wherein said opening includes an upstanding external threaded portion adapted to be engaged by a correspondingly shaped nut, said removable membrane being disposed between said threaded portion and said nut such that tightening thereof causes said membrane to seal the opening.

7. A tank according to claim 1 wherein said liquid is wine.

8. A tank according to claim 1 wherein the tank further includes an internal frame adapted to suspend at least one wooden member for the purpose of oaking of the liquid contained therein.

9. An apparatus for the storage and/or maturation of a liquid, said apparatus including: a vessel adapted to hold a quantity of the liquid therein, said vessel being gas impermeable or at least having a low oxygen transfer rate to facilitate storage of said liquid; and a means of accommodating a gas permeable membrane in a headspace of said vessel, said gas permeable membrane having a higher oxygen transfer rate relative to the vessel to facilitate the controlled ingress of oxygen into said vessel.

10. An apparatus according to claim 9 wherein said vessel is constructed of polyethylene.

11. An apparatus according to claim 9 wherein said membrane is constructed of a gas permeable material.

12. An apparatus according to claim 9 wherein said membrane is constructed of silicon rubber.

13. An apparatus for storage and/or maturation of a liquid, said apparatus including:
a vessel adapted to hold a quantity of the liquid therein; a substantially rigid frame including a base adapted to support said vessel and
prevent undesirable expansion of the vessel, said base being angled to facilitate draining of liquid out from the vessel.

14. An apparatus according to claim 13 wherein the frame is adapted to accommodate the prongs of a forklift.

15. An apparatus for storage and/or maturation of a liquid as in claim 9, said apparatus further including:
an integrally formed fitting extending a predetermined distance outwardly from a wall of said vessel, said fitting configured to receive an attachment using an external fastening means, said fitting used to allow the passage of liquid there through.

16. An apparatus according to claim 15 wherein said apparatus further includes a seal disposed between said fitting and said attachment.

17. An apparatus according to claim 15 wherein said attachment is configured for connection to a hose.

18. An apparatus according to claim 15 wherein said fitting and said attachment include circular cross sections, and said external fastening means is in the form of a hinged annular clamp.

19. An apparatus for storage and/or maturation of a liquid as in claim 15, said apparatus further including a substantially rigid frame including a base adapted to support said vessel and prevent undesirable expansion of the vessel, said base being angled to facilitate draining of liquid out from said fitting.

20. An apparatus according to claim 19 wherein the liquid is wine and is described with reference to the drawings.
